(19) United States
(12) Patent Application Publication
(10) Pub. No.: US 2006/0204153 A1
(43) Pub. Date: Sep. 14, 2006

(54) Compact resilient anisotropic support for bearing

(75) Inventors: Mohsiul Alam, Chandler, AZ (US); Doug K. Spencer, Mesa, AZ (US)

Correspondence Address: Honeywell International, Inc., Law Dept. AB2, P.O. Box 2245, Morristown, NJ, 07962-9806, US

(73) Assignee: Honeywell International Inc., Morristown, NJ (US)

(21) Appl. No.: 11/078,864

(22) Filed: Mar. 10, 2005

(51) Int. Cl. F16C 27/00

(52) U.S. Cl. 384/99

(57) ABSTRACT

A support for a bearing comprises a resilient ring having unevenly spaced inner and outer bumpers. The unevenly spaced bumpers provide anisotropy to the rotor to preclude non-synchronous vibration. The inner bumpers can be ground to provide a vertical offset of the rotor centerline to accommodate the deflection due to the rotor weight. A tangential groove in the outer bumper allows oil passage during ring deflection so that oil can be squeezed out under dynamic load, providing additional viscous damping to the rotor.

### CROSS-REFERENCE TO RELATED APPLICATIONS

This application is related to co-pending and commonly assigned U.S. patent application Ser. No. 10/967,979, filed Oct. 19, 2004, entitled “Compact Compliant Centering Support for Squeeze Film Damper”, which is incorporated by reference herein.

### BACKGROUND OF THE INVENTION

The present invention generally relates to gas turbine engines and, more particularly, to bearing support assemblies that interface between the bearing assemblies and the support housing of the gas turbine engine.

The gas turbine engine may include rotating components such as a fan, a compressor, and a turbine. The rotating components may be clamped either by a tieshaft or bolted flange joints to form a rotor group. Two or more bearing assemblies may support the rotor group. The bearing assemblies may be surrounded by the support housing, which may be connected to an engine case. During high-speed rotation of the rotor group, forces may be transmitted from the rotor group to the support housing.

The forces transmitted from the rotor group to the support housing may include synchronous vibration and non-synchronous vibration. The synchronous vibration may be caused by a rotating mass imbalance (i.e. the mass center of the rotor is not coincident with its geometric center). The non-synchronous vibration may occur when a radial deflection of the rotor results in a tangential force normal to the deflection. Reducing the forces transmitted from the rotor to the support housing improves the operating characteristics of the engine.

To damp the effect of the transmitted forces, a film of oil (“squeeze film”) has been confined between the rotor assembly and the support structure. The oil in the squeeze film is under pressure and acts as a damper. Adequate damping requires that the oil film not be too thick or too thin. The rotating rotor assembly may not remain concentric, with respect to the squeeze film cavity, because of the weight of the rotor. To counteract the tendency for the rotating assembly to operate off center, thus compromising the performance of the squeeze film damper, various conventional designs attempt to use a centering feature to maintain a uniform squeeze film damper thickness.

U.S. Pat. No. 4,981,415, for example, centers the shaft of a gas turbine engine by utilizing segmented spring(s) mounted on either side of, or surrounding, the bearing supporting the shaft. Although the described segmented ring may enhance damper performance by centering the squeeze film, reducing synchronous vibration, it does not have an offset feature to reduce asymmetric rub caused by the rotor under 1g deflection. Additionally, the provided segmented ring does not have anisotropy to suppress the force responsible for non-synchronous vibration.

Various anisotropic supports that reduce non-synchronous vibration have been devised in the past. Anisotropic designs provide support devices having different values of stiffness. For example, some designs provide the different values of stiffness by comprising two of more components, with individual components varying in stiffness. One such multi-component support comprises pivot supports and blocks and can only accommodate journal bearings. Other anisotropic supports have comprised two rings connected by asymmetrically arranged beams to provide stabilizing cross-coupling stiffness. Although the disclosed anisotropic supports can reduce non-synchronous vibration, they are bulky, expensive and/or difficult to retrofit to existing engines.

As can be seen, there is a need for improved bearing support assemblies. While various designs for bearing support assemblies have been proposed and used in the gas turbine engines, improved designs are required for optimum operating characteristics. Improved designs are needed to provide a centering feature to enhance modal damping, to provide compliance to the rotordynamic system to precisely place the rigid body modes outside the operating envelope, to minimize impact on component durability and cabin noise, to center the rotor for possible asymmetric rub, limiting maneuver deflection, and reducing vibration. In addition to the above-mentioned features an improved design is needed that also provides anisotropy to the rotor to preclude non-synchronous vibration. An improved support is needed that combines all these features in a compact design that is lightweight and inexpensive and that can be retrofitted easily to an existing gas turbine engine for better rotor dynamic performance.

### SUMMARY OF THE INVENTION

In one aspect of the present invention, an assembly comprises an annular member; a plurality of inner bumpers positioned radially inward from the annular member; and a plurality of outer bumpers positioned radially outward from the annular member, the inner and outer bumpers unevenly spaced about the annular member.

In another aspect of the present invention, an apparatus comprises a ring shaped structure; and a plurality of member segments, the member segments being a part of the ring structure between the inner and outer bumpers, and wherein at least two of the member segments have unequal circumferential length.

In still another aspect of the present invention, an apparatus for supporting a bearing assembly in an engine comprises an annular member radially outward from the bearing assembly; at least one inner bumper between the annular member and the bearing assembly; and at least one outer bumper radially outward from the annular member, the inner bumper and the outer bumper positioned to provide anisotropic stiffness to the annular member.

In another aspect of the present invention, an assembly for an engine comprises a bearing assembly having an inner race, an outer race and a rolling element, the inner race fixed to a rotor of the engine; a support housing positioned radially outward from the outer race; and an annular member positioned between the support housing and the outer race, the annular member having a plurality of unevenly spaced inner and outer bumpers.

In yet another aspect of the present invention, an assembly comprises an annular member having a radial thickness of between about 0.05 inches and about 0.10 inches and having an axial width of between about 0.20 inches and about 1.00 inches; a plurality of inner bumpers positioned radially inward from and integral to the annular member, the inner bumpers unevenly spaced about the annular member, each inner bumper having a radial height of between about 0.004 inches and about 0.010 inches such that the inner bumpers positioned towards a vertical bottom of the annular member have a greater radial height than the inner bumpers positioned towards a vertical top of the annular member; and a plurality of outer bumpers positioned radially outward from and integral to the annular member, the outer bumpers unevenly spaced about the annular member, each outer bumper having a radial height of between about 0.004 inches and about 0.010 inches and having a tangential groove.

In a further aspect of the present invention, a method for rotatably supporting a rotor with a support housing comprises the steps of suspending the rotor from the support housing upon at least two bearing assemblies; centering the rotor with a bearing support assembly, wherein the bearing support assembly includes unevenly spaced inner and outer bumpers; and establishing a squeeze film damper between an outer race of the bearing assembly and the support housing.

These and other features, aspects and advantages of the present invention will become better understood with reference to the following drawings, description and claims.

### BRIEF DESCRIPTION OF THE DRAWINGS

FIG. 1 is a cross-sectional view of a gas turbine engine according to one embodiment of the present invention;

FIG. 2 is a plan view of a bearing support assembly according to one embodiment of the present invention;

FIG. 3a is a close-up view of a portion of the bearing support assembly of FIG. 2;

FIG. 3b is a cross-section view through line 3b of FIG. 3a;

FIG. 4 is a plot of load versus displacement according to one embodiment of the present invention;

FIG. 5 is a flow chart of a method for damping forces transmitted from a rotor to a support housing according to one embodiment of the present invention;

FIG. 6a is a plot of vibration amplitude versus frequency for a non-isotropic support;

FIG. 6b is a plot of vibration amplitude versus frequency for an isotropic support;

FIG. 6c is a plot of vibration amplitude versus frequency for a non-isotropic support and an isotropic support; and

FIG. 7 is a plot of vibration amplitude versus rotor speed for a compliant support and a non-centered squeeze film.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides bearing support assemblies for gas turbine engines and methods for producing the same. The bearing support assemblies according to the present invention may find beneficial use in many industries including aerospace, automotive, and electricity generation. The present invention may be beneficial in applications including manufacturing and repair of aerospace components. This invention may be useful in any gas turbine engine bearing support application. This invention may be applicable to gas turbine as well as any other turbo machinery. The present invention may be useful with any form of bearing elements, e.g., ball, roller etc.

In one embodiment, the present invention provides a bearing support assembly for a gas turbine engine. The bearing support assembly may comprise a ring with bumpers spaced around the circumference at the inside and outside diameters to form spring elements between the bumpers. The resilient support assembly may center the bearing to maintain a uniform squeeze film damper thickness. The bumpers on the inside diameter may be ground to provide a vertical offset to eliminate asymmetric rub. Unlike the prior art, the bumpers may be spaced unequally to provide different stiffness in the horizontal and vertical directions, providing anisotropy to the rotor to preclude non-synchronous vibration. Unlike prior art anisotropic supports, tangential grooves may be provided on the outer diameter bumpers to allow the oil to squeeze out when the ring is deflected, providing additional viscous damping.

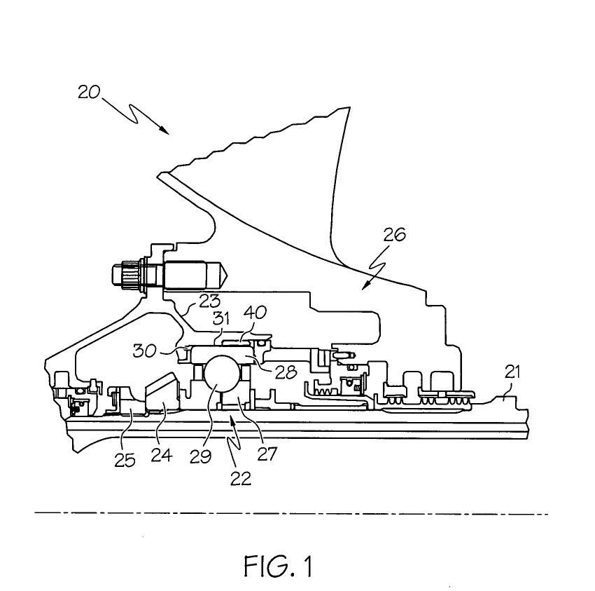

A portion of a gas turbine engine is depicted in FIG. 1. The engine 20 may comprise a rotor 21, a bearing assembly 22 and a support housing 23. The bearing assembly 22 may be stacked with a bevel gear 24 and clamped by a nut 25. The bearing assembly 22 may include an inner race 27, an outer race 28 and a rolling element 29. The inner race 27 may be fixed with the rotor 21. A squeeze film damper 31 may be formed between the support housing 23 and the outer race 28 of the bearing assembly 22. The squeeze film damper 31 may be formed by a gap (not shown) between the support housing inner diameter and the bearing assembly outer diameter. The support housing 23 may be clamped with the engine case 26. A bearing support assembly 40 of the present invention may be positioned between the support housing 23 and the bearing assembly 22. The bearing support assembly 40 may be positioned radially outward from the bearing assembly 22. The support housing 23 may include an oil supply line (not shown) to feed oil (not shown) to an annular groove 30. Both the squeeze film damper 31 and the bearing support assembly 40 may use the oil from the annular groove 30.

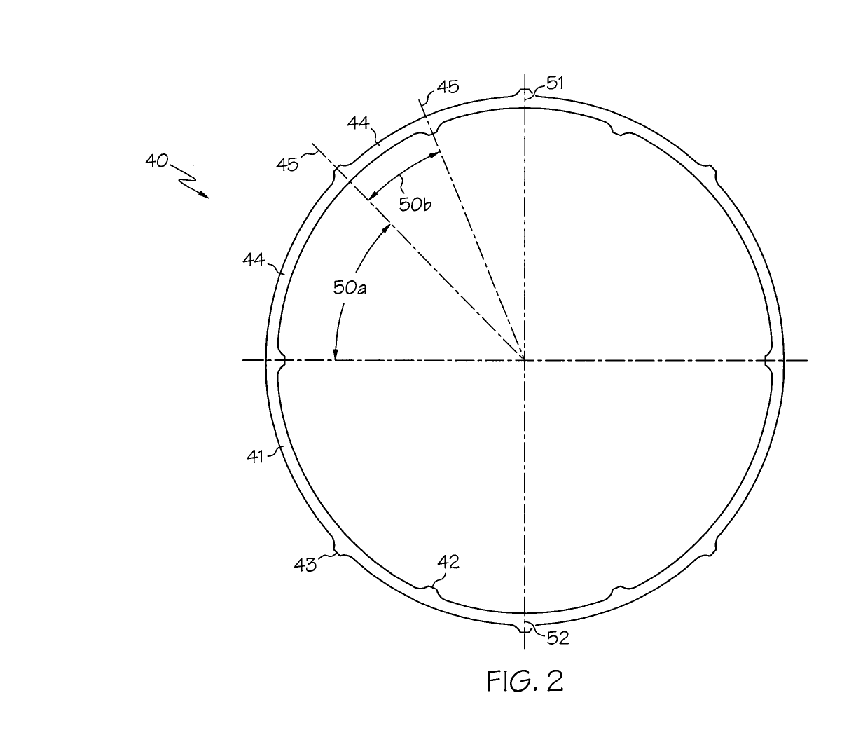

An embodiment of the bearing support assembly 40 is depicted in FIG. 2. The bearing support assembly 40 may comprise an annular member 41, a plurality of inner bumpers 42 and a plurality of outer bumpers 43. The inner bumpers 42 may be positioned radially inward from the annular member 41. The outer bumpers 43 may be positioned radially outward from the annular member 41.

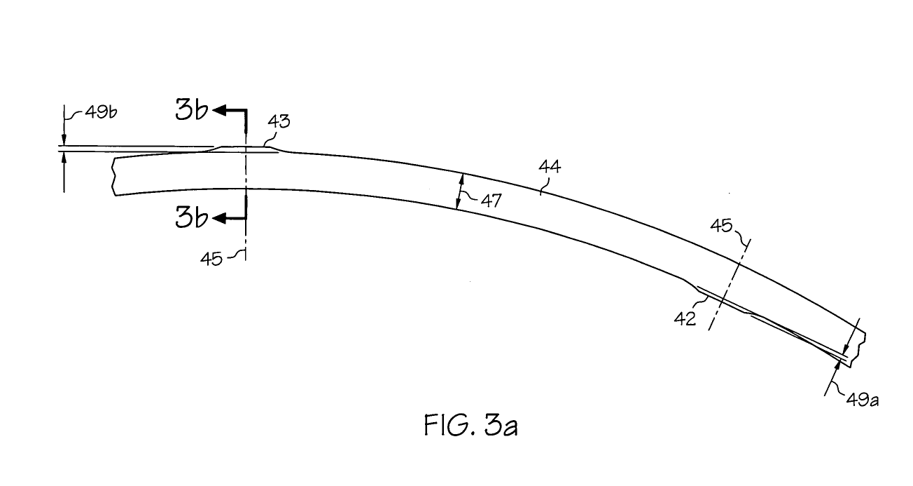

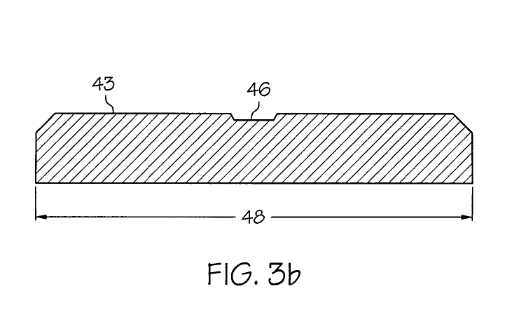

The annular member 41 may comprise a ring shaped structure. The annular member 41 may comprise a metal, such as steel or titanium, or a composite. A useful material may depend on factors including the operating temperature of the gas turbine engine 20 and the operating speed of the rotor 21. The dimensions of the annular member 41 may vary with application and may depend on factors including the dimensions of the bearing assembly 22 and the mass of the rotor 21. For some applications, the annular member 41 may have a radial thickness 47 (see FIG. 3a) of between about 0.05 inches and about 0.10 inches. For some applications, the annular member 41 may have an axial width 48 (see FIG. 3b) of between about 0.20 inches and about 1.00 inches.

The annular member 41 may comprise a plurality of member segments 44 (spring elements). Each member segment 44 may comprise a portion of the annular member 41. The member segment 44 may extend between two radial lines 45, one radial line 45 through one inner bumper 42 and one radial line 45 through the adjacent outer bumper 43. In other words, the member segment 44 may be an arc shaped portion of the annular member 41 extending from the center of one inner bumper 42 to the center of the adjacent outer bumper 43. The member segments 44 may vary in length because the bumpers 42,43 may be spaced unevenly about the annular member 41.

The inner and outer bumpers 42,43 may be alternated around the circumference of the annular member 41 to form spring elements between the bumpers 42,43. The number of inner bumpers 42 may equal the number of outer bumpers 43. The alternating arrangement of inner and outer bumpers 42,43 may allow the member segments 44 to deflect during engine operation. Although the embodiment shown in FIG. 2 comprises six inner bumpers 42 and six outer bumpers 43, the present invention may comprise any number of bumpers 42,43. The radial thickness 47 and axial width 48 of the annular member 41 along with the number of inner and outer bumpers 42,43 may determine the stiffness of the bearing support assembly 40.

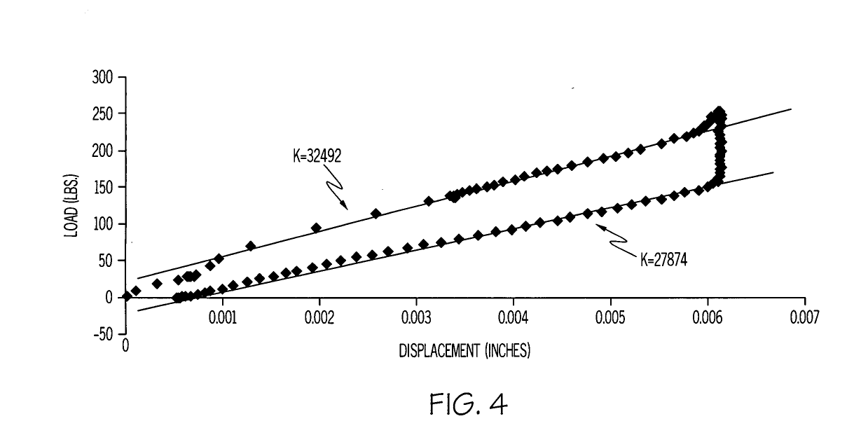

Compliance of the bearing support assembly 40, which may be determined precisely by selecting the cross-section of the annular member 41 and the bumpers 42,43, may keep the rigid body modes below ground-idle speed so that detrimental vibration is eliminated from the operating range of the rotor 21 for a more durable engine 20. Factors effecting stiffness may include bumper number, bumper placement, bumper dimensions and annular member dimensions. Such a bearing support assembly, with 8 inner and 8 outer bumpers, was bench tested. The result, as shown in FIG. 4, shows that it is possible to achieve very low stiffness with such a bearing support. Note, during loading, bearing support shows higher stiffness (32,492 lb/in) than during unloading (27,874 lb/in) implying that the hysterics builds up at the bumper.

The inner and outer bumpers 42,43 may be arranged asymmetrically, forming member segments 44 of varying circumferential length, to provide anisotropic stiffness. For example, as depicted in FIG. 2, the bumpers 42,43 may form a member segment 44 with length 50a, which is longer than the member segment 44 with length 50b. Because stiffness may be a cubic function of the length of the member segment 44, the bearing support assembly 40 shown in FIG. 2 may have a much lower stiffness in the horizontal direction than in the vertical direction. The vertical and horizontal directions may be defined with reference to the direction of the force of gravity on the installed bearing support assembly 40, with vertical being about parallel to gravity. The placement of the bumpers 42,43 in a non-symmetric fashion may provide anisotropy to the bearing support assembly 40. This anisotropy may provide beneficial cross-coupling stiffness to counteract rotor instability arising from the tangential forcing function created by the turbine aerodynamics, working spline, lab seal etc.

The inner bumpers 42 may be integral to the annular member 41. The dimensions of the inner bumper 42 may vary with application. For some applications the inner bumper 42 may have a radial height 49a (see FIG. 3a) of between about 0.004 inches and about 0.010 inches. The inner bumpers 42 may be ground to provide a vertical offset of the rotor centerline to accommodate the deflection due to the rotor weight. The inner bumpers 42 may be of unequal radial height 49a with respect to one another. For example, the inner bumpers 42 towards a vertical bottom 52 of the annular member 41 may have a greater radial height 49a than the inner bumpers 42 towards a vertical top 51 of the annular member 41. This offset feature may allow the turbine (not shown) and the compressor (not shown) of the engine 20 to run at the centerline of the respective shroud (not shown). By supporting the weight of the rotor 21 by the bearing support assembly 40, the detrimental effect of 1g load may be eliminated from the squeeze film damper performance. The present invention may lift the rotor 21 in the squeeze film cavity for centered circular operation of the squeeze film damper 31, thereby increasing the effectiveness of the damper to reduce bearing load and vibration. The axial width of the inner bumper 42 may be about equal to the axial width 48 of the annular member 41. For some applications, the inner bumpers 42 may be integral to the outer race 28 of the bearing assembly 22. For applications comprising inner bumpers 42 integral to the outer race 22, the inner bumpers 42 may be clocked with respect to the outer bumpers 43 to provide anisotropic stiffness.

The outer bumpers 43 may be integral to the annular member 41. The dimensions of the outer bumper 43 may vary with application. For some applications the outer bumper 43 may have a radial height 49b (see FIG. 3a) of between about 0.004 inches and about 0.010 inches. The radial height 49b of the outer bumpers 43 may be limited to control rotor deflection, thereby protecting components during high maneuver and blade loss events. A tangential groove 46 may be provided in the outer bumper 43 (see FIG. 3b) to provide oil passage during ring deflection so that oil can be squeezed out under dynamic load. The tangential groove 46 may be in flow communication with the oil supply line of the support housing 23, the annular groove 30 and the squeeze film damper 31. This feature may provide additional viscous damping to the rotor 21. The axial width of the outer bumper 43 may be about equal to the axial width 48 of the annular member 41. The outer bumpers 43 of the bearing support assembly 40 may be interference fit with the support housing 23. In another embodiment, the outer bumpers 43 may be integral to the support housing 23 and interference fit to the annular member 41. For applications comprising outer bumpers 43 integral to the support housing 23, the outer bumpers 43 may be clocked with respect to the inner bumpers 42 to provide anisotropic stiffness.

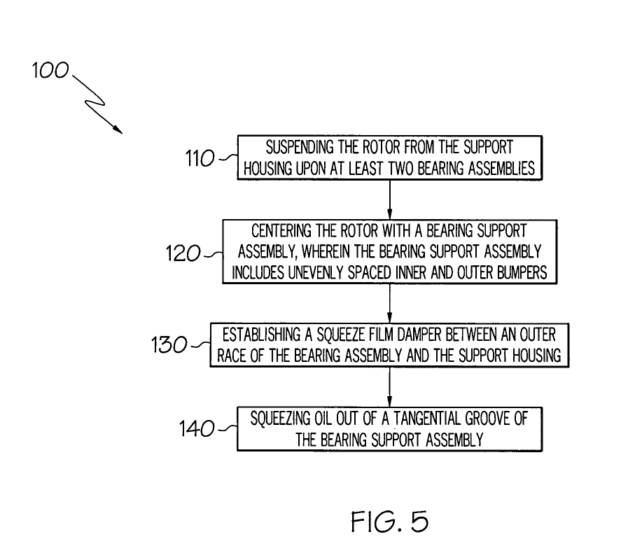

A method 100 for rotatably supporting a rotor with a support housing is depicted in FIG. 5. The method 100 may comprise a step 110 of suspending the rotor 21 from the support housing 23 upon at least two bearing assemblies 22. Next, a step 120 may comprise centering the rotor 21 with a bearing support assembly 40, wherein the bearing support assembly 40 includes unevenly spaced inner and outer bumpers 42,43. A step 130 may comprise establishing a squeeze film damper 31 between an outer race 28 of the bearing assembly 22 and the support housing 23. The method 100 may comprise the further step 140 of squeezing oil out of a tangential groove 46 of the bearing support assembly 40.

### EXAMPLE 1

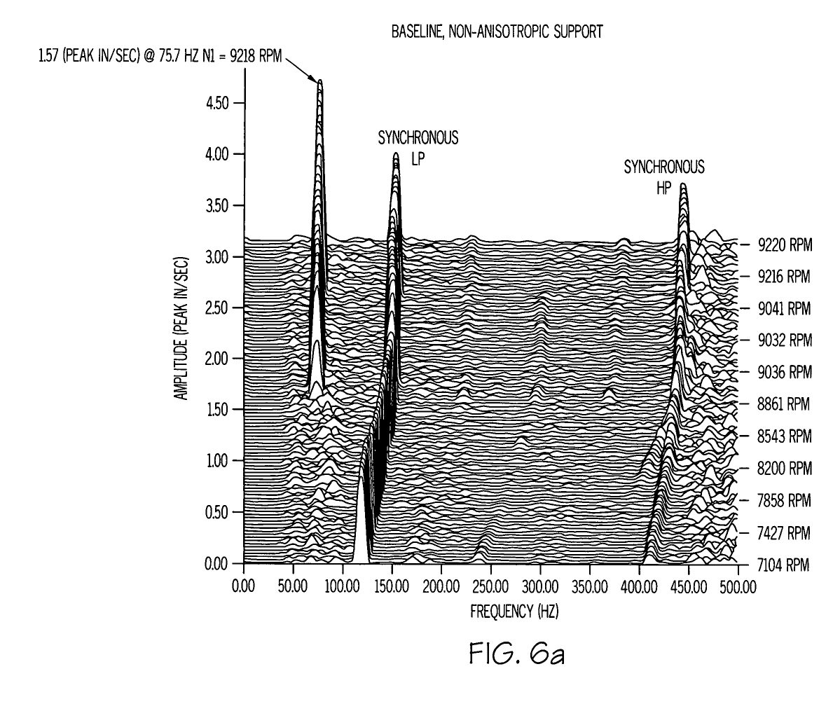

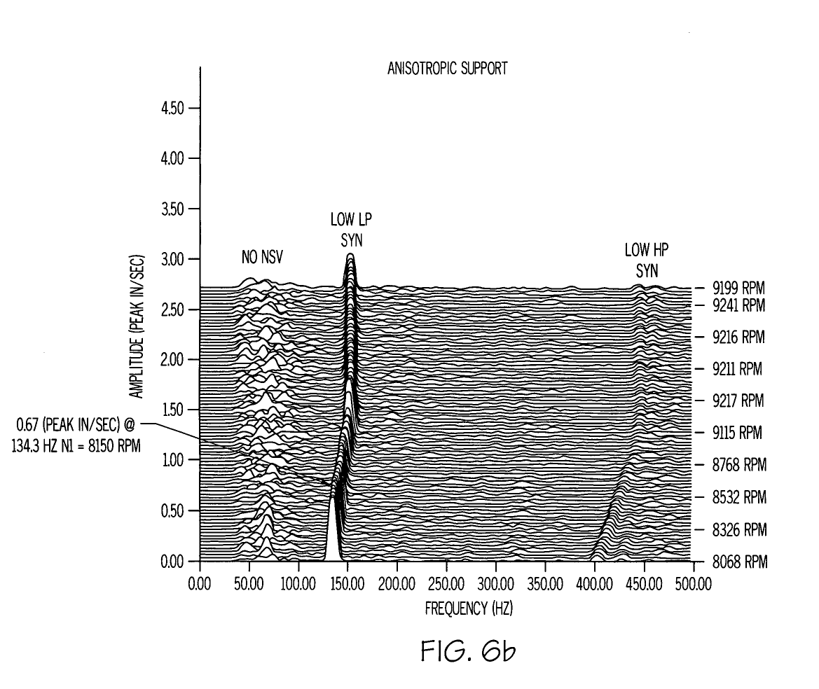

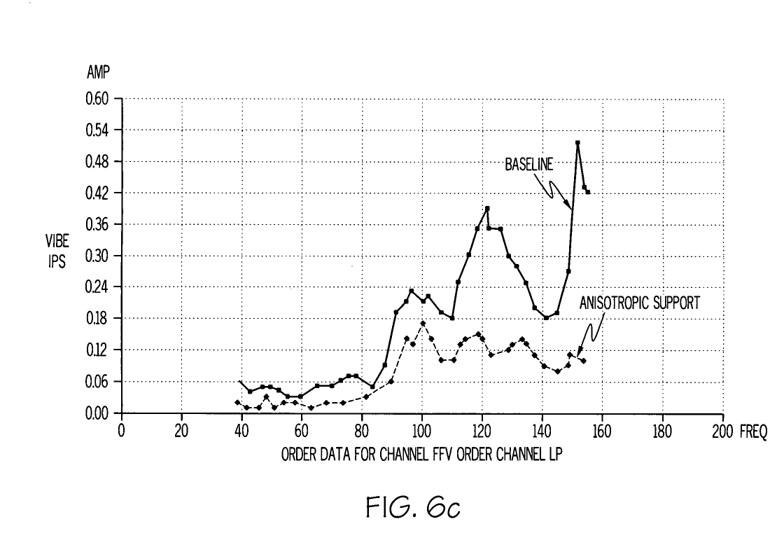

A bearing support assembly with anisotropic stiffness was compared to a support without aniostropic stiffness. As can be seen from a back to back engine test (FIGS. 6a-6c), the anisotropic support effectively controlled non-synchronous vibration (NSV) in the engine. The anisotropic support eliminated NSV and reduced synchronous vibration.

### EXAMPLE 2

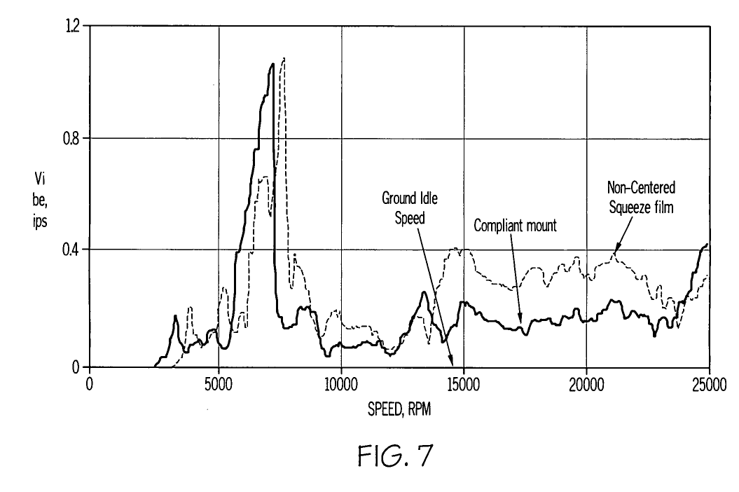

A compact compliant support, without anisotropy, was tested in another engine. The test data, shown in FIG. 7, shows the benefit of compliance to lower the vibration and shift down the critical speed. The present invention may combine the benefits of the compliant support with the benefits of the anisotropic support to create a compact light weight apparatus.

As can be appreciated by those skilled in the art, the present invention provides improved bearing support assemblies and methods for their production. The bearing support assemblies can lift the rotor inside the hydraulic mount cavity and eliminate rotor weight effect on the damper performance. The provided support assemblies can be offset in the vertical direction to center the rotor under 1g deflection to eliminate rub at the 6 o'clock location of a shroud. The outer bumper height can be controlled to limit maneuver deflection of the rotor. A compact, lightweight, and inexpensive apparatus is provided that can be retrofitted to an existing engine to lower vibration and neutralize unstable forces that creates unacceptable NSV.

It should be understood, of course, that the foregoing relates to exemplary embodiments of the invention and that modifications may be made without departing from the spirit and scope of the invention as set forth in the following claims.

We claim:

1. An assembly comprising:
an annular member;
a plurality of inner bumpers positioned radially inward from said annular member; and
a plurality of outer bumpers positioned radially outward from said annular member, said inner and outer bumpers unevenly spaced about said annular member.

2. The assembly of claim 1, wherein at least one inner bumper is integral to said annular member.

3. The assembly of claim 1, wherein at least one outer bumper is integral to said annular member.

4. The assembly of claim 3, wherein said outer bumper has a tangential groove.

5. The assembly of claim 1, wherein said annular member has a radial thickness of between about 0.05 inches and about 0.10 inches.

6. The assembly of claim 5, wherein said annular member has an axial width of between about 0.20 inches and about 1.00 inches.

7. The assembly of claim 1, wherein at least one inner bumper has a radial height of between about 0.004 inches and about 0.010 inches.

8. The assembly of claim 1, wherein at least one outer bumper has a radial height of between about 0.004 inches and about 0.010 inches.

9. The assembly of claim 1, wherein the inner bumpers positioned towards a vertical bottom of the annular member have a greater radial height than the inner bumpers positioned towards a vertical top of the annular member.

10. The assembly of claim 1, wherein said annular member comprises a metal or a composite.

11. An apparatus comprising:
a ring shaped structure; and
a plurality of member segments, the member segments being a part of the ring structure between the inner and outer bumpers, and wherein at least two of the member segments have unequal circumferential length.

12. The apparatus of claim 11, wherein each said inner and outer bumper has a radial height of between about 0.004 inches and about 0.010 inches.

13. The apparatus of claim 11, wherein said ring shaped structure comprises a metal.

14. The apparatus of claim 11, wherein said ring shaped structure comprises a composite.

15. The apparatus of claim 11, wherein each outer bumper has a tangential groove.

16. The apparatus of claim 11, wherein at least one inner bumper positioned towards a vertical bottom of said ring shaped structure has a greater radial height than the radial height of at least one inner bumper positioned towards a vertical top of said ring shaped structure.

17. An apparatus for supporting a bearing assembly in an engine comprising:
an annular member disposed radially outward from said bearing assembly;
at least one inner bumper between said annular member and said bearing assembly; and
at least one outer bumper radially outward from said annular member, said inner bumper and said outer bumper positioned to provide anisotropic stiffness to said annular member.

18. The apparatus of claim 17, wherein said outer bumper has a tangential groove in flow communication with a squeeze film damper of said engine.

19. The apparatus of claim 17, wherein said outer bumper is integral to a support housing of said engine.

20. The apparatus of claim 19, wherein said outer bumper is interference fit to said annular member.

21. The apparatus of claim 17, wherein said inner bumper is integral to an outer race of said bearing assembly.

22. An assembly for an engine comprising:
a bearing assembly having an inner race, an outer race and a rolling element, said inner race fixed to a rotor of said engine;
a support housing positioned radially outward from said outer race; and
an annular member positioned between said support housing and said outer race, said annular member having a plurality of unevenly spaced inner and outer bumpers.

23. The assembly of claim 22, further comprising a squeeze film damper between said support housing and said outer race.

24. The assembly of claim 23, wherein said support housing includes an oil supply line in flow communication with said squeeze film damper.

25. The assembly of claim 24, wherein said outer bumper includes a tangential groove in flow communication with said squeeze film damper.

26. The assembly of claim 22, wherein said support housing is clamped to an engine case of said engine.

27. The assembly of claim 22, wherein said bearing assembly is clamped by a nut to said rotor.

28. An assembly comprising:
an annular member having a radial thickness of between about 0.05 inches and about 0.10 inches and having an axial width of between about 0.20 inches and about 1.00 inches;
a plurality of inner bumpers positioned radially inward from and integral to said annular member, said inner bumpers unevenly spaced about said annular member, each said inner bumper having a radial height of between about 0.004 inches and about 0.010 inches such that the inner bumpers positioned towards a vertical bottom of said annular member have a greater radial height than the inner bumpers positioned towards a vertical top of said annular member; and
a plurality of outer bumpers positioned radially outward from and integral to said annular member, said outer bumpers unevenly spaced about said annular member, each said outer bumper having a radial height of between about 0.004 inches and about 0.010 inches and having a tangential groove.

29. A method for rotatably supporting a rotor with a support housing comprising the steps of:
suspending the rotor from the support housing upon at least two bearing assemblies;
centering the rotor with a bearing support assembly, wherein the bearing support assembly includes unevenly spaced inner and outer bumpers; and
establishing a squeeze film damper between an outer race of the bearing assembly and the support housing.

30. The method of claim 29, further comprising a step of squeezing oil from a tangential groove of said bearing support assembly.

31. The method of claim 29, wherein said bearing support assembly provides a vertical offset to said rotor.

32. The method of claim 29, wherein said bearing assembly includes an inner race, an outer race and a rolling element.

33. The method of claim 32, wherein said inner race is fixed with said rotor.
